(19) United States
(12) Patent Application Publication
(10) Pub. No.: US 2011/0164319 A1
(43) Pub. Date: Jul. 7, 2011

(54) TILT COMPENSATION FOR STEREOSCOPIC VISUAL DISPLAYS

(76) Inventor: Olivier Michel Contant, Redmond, WA (US)

(21) Appl. No.: 12/850,497

(22) Filed: Aug. 4, 2010

Related U.S. Application Data
(60) Provisional application No. 61/231,017, filed on Aug. 4, 2009.
(60) Provisional application No. 61/242,800, filed on Sep. 16, 2009.
(60) Provisional application No. 61/370,426, filed on Aug. 3, 2010.

(51) Int. Cl. G02B 27/26; G02B 27/22

(52) U.S. Cl. 359/465; 359/464

(57) ABSTRACT

A tilt compensation system is described herein that provides an inexpensive and effective solution to remove stereoscopy artifacts, particularly artifacts associated with head tilt issues. When applied to stereoscopic eyewear, the system can improve the viewing experience for viewers. In some embodiments, the tilt compensation system includes a lens assembly that is separate from a frame assembly, so that the lens assembly can move in relation to the frame assembly. When the viewer tilts his head, the system automatically compensates for the head tilt of the user by mechanically, electronically, or electromagnetically rotating the lenses of the eyewear at an opposite angle. Thus, the tilt compensation system allows cheaper filtering technologies to be used for 3D presentations without the downsides of eyewear that experiences ghosting in response to tilting.

### CROSS-REFERENCE TO RELATED APPLICATIONS

The present application claims the benefit of U.S. Provisional Patent Application No. 61/231,017 (Attorney Docket No. CONTANT006) entitled “METHOD AND APPARATUS FOR ELIMINATING STEREOSCOPIC CROSSTALK,” and filed on Aug. 4, 2009; U.S. Provisional Patent Application No. 61/242,800 (Attorney Docket No. CONTANT003) entitled “METHOD AND APPARATUS FOR ELIMINATING STEREOSCOPIC GHOSTING,” and filed on Sep. 16, 2009; and U.S. Provisional Patent Application No. 61/370,426 (Attorney Docket No. CONTANT007) entitled “ELIMINATING STEREOSCOPIC GHOSTING,” and filed on Aug. 3, 2010, which are hereby incorporated by reference.

### BACKGROUND

The three-dimensional (3D) display of movies, television shows, and other visual media (e.g., computer user interfaces) are increasing in popularity. 3D images are typically produced by displaying different information to a human viewer's left and right eyes. One form of 3D display, stereoscopic projection, involves projecting information for the left and right eyes on a single display screen and using stereoscopic eyewear to enable the left eye to see only the left eye image and the right eye to see only the right eye image. A stereoscopic projection is considered high quality when the overall visual experience of the user is fully focused and not blurred, which is achieved when the left eye solely and clearly sees the left eye image and when the right eye solely and clearly sees the right eye image. Crosstalk occurs if the left and right image channels are incompletely isolated. Crosstalk is a physical entity, and is related to ghosting, which is the perception of crosstalk and therefore a psychophysical entity. Crosstalk detracts from the enjoyment of a stereoscopic film due to the ghosting effect.

Methods for 3D stereoscopic projection include Anaglyph, Linear Polarization, Circular Polarization, Shutter Glasses, and Spectral Separation. Anaglyph is the oldest technology, and provides left/right eye separation by filtering the light through a two color filter, commonly red for one eye, and cyan for the other eye. At the projector, the left eye image is typically filtered through a red filter, and the right image is filtered through a cyan filter. The eyewear includes a red filter for the left eye, and a cyan filter for the right eye. This method works well for black and white original images, but is not well suited for color images since the colorization of the eyewear alters normal image colors.

Linear Polarization 3D provides separation at the projector by filtering the left eye through a linear polarizer, typically oriented vertically, and filtering the right eye image through a linear polarizer, typically oriented horizontally. The eyewear includes a linear polarizer for the left eye and a linear polarizer for the right eye that are both oriented at 90 degrees from another. The projection screen is of the polarization preserving type, commonly referred to as a “silver screen” because of its distinctive color. Linear Polarization allows a full color image to be displayed with little color distortion. The main problem with Linear Polarization is that any tilt in the viewer's head will produce crosstalk from one eye to another.

Circular Polarization 3D addresses the Linear Polarization problem of requiring the viewer to keep his head oriented vertically. Circular Polarization provides separation at the projector by filtering the left eye image through a typically left-handed circular polarizer, and filtering the right eye image through a right handed circular polarizer. The eyewear includes a left-handed circular polarizer for the left eye and a right-handed circular polarizer for the right eye. A silver screen is also needed for this approach.

Shutter Glasses provide separation by multiplexing the left and right images in time. A filter for separation at the projector is not required. The eyewear includes shutters that electronically shutter the lens in time with the projector frame rate. The left eye image is first displayed, while the right eye is covered with the shutter, followed by the right eye image while the left eye is covered with the shutter. Since having a direct, wired connection to the Shutter Glasses in a theatre is impractical, a wireless or infrared signaling method is used to provide a timing reference for the left/right eye shuttering. This method uses an infrared (IR) or radio frequency (RF) transmitter in the auditorium. The Shutter Glasses are expensive and hard to clean, use batteries that need frequent replacement or charging, and are limited in their switching rate. Shutter glasses are only practical for use with expensive, specialized electronic projection systems since very few film projectors provide the signal used to synchronize the shutter glasses with the frame rate.

Spectral Separation provides separation at the projector by filtering the left and right eye spectrally. The system differs from anaglyph in that the filters for the left and right eye each pass a portion of the red, green, and blue spectrum, providing for a full color image. The band pass spectrum of the left eye filter is complementary to the band pass spectrum of the right eye filter. The eyewear includes filters with the same general spectral characteristics of the filters used in the projector. While this method provides a full color image, it involves color compensation to make the colors in the left and right eye match the colors that were present in the original image, and there is a small reduction in the color gamut compared to the gamut of the projector.

Despite the existence of many stereoscopy technologies, the display and visioning of artifact-free 3D images remains difficult. Circular Polarization is currently favored by movie theaters, but uses filters that are more expensive. Circular polarization typically involves passing unpolarized light through a linear polarizer followed by a quarter-wave plate. The use of two filters increases expense and further dims the light that reaches the viewer. Each filter blocks some light, which registers to the viewer as a dimmer image. A two-filter system also takes caution to make and setup correctly, both at the glasses and the projection source.

### BRIEF DESCRIPTION OF THE DRAWINGS

FIG. 1 is a block diagram that illustrates components of the tilt compensation system, in one embodiment.

FIG. 2 is a flow diagram that illustrates processing of the tilt compensation system to adjust for tilt, in one embodiment.

FIG. 3 is a flow diagram that illustrates processing of the tilt compensation system to monitor viewer behavior, in one embodiment.

FIG. 4 illustrates a front view of eyewear embodying the tilt compensation system, in one embodiment.

### DETAILED DESCRIPTION

A tilt compensation system is described herein that provides an inexpensive and effective solution to remove stereoscopy artifacts, particularly artifacts associated with head tilt issues. When applied to stereoscopic eyewear, the system can improve the viewing experience for viewers. Although tilt problems are most often associated with linear light polarization filtering technology, the system can also improve other technologies such as circular light polarization filtering technology that, for example, may contain some minor color artifacts when tilting the head (e.g., in the case of 3D monitor displays), or the like. In some embodiments, the tilt compensation system includes a lens assembly that is separate from a frame assembly, so that the lens assembly can move in relation to the frame assembly. When the frame assembly leans right or left, such as due to a wearer tilting his head, the lens assembly attempts to maintain a correct angular relationship with the visual display. For example, the lens assembly may be calibrated to maintain a horizontal filter parallel to the ground and a vertical filter at a right angle to the ground. Because the screen is also level with the ground, and orientations of the polarization of the projected left and right images are either horizontal or vertical, the lens assembly stays at the correct angular relationship with the visual display. When the viewer tilts his head, the system automatically compensates for the head tilt of the user by mechanically, electronically, or electromagnetically rotating the lenses of the eyewear at an opposite angle. Thus, the tilt compensation system allows cheaper filtering technologies to be used for 3D presentations without the downsides of eyewear that experiences ghosting in response to tilting.

In some embodiments, the tilt compensation system provides a surface suitable for advertising to wearers of stereoscopic eyewear. For example, a movie theater can provide eyewear with advertisements targeted to an audience of a particular movie. The eyewear may also provide a souvenir that viewers will keep and thus will continue to be exposed to the advertisements long after the movie is experience is over.

In some embodiments, the tilt compensation system provides an effective solution to measure and monitor viewers' behaviors while viewing a display screen. For example, the eyewear worn by the viewer may include a camera or other sensors, such as those used for tilt compensation, that can detect facial expressions, movements, and so forth that occur while the viewer is wearing the eyewear. From these detected actions, the system may infer whether the viewer is laughing, jumping back in surprise, and so on. These user measurements contain valuable information that can be used to extract statistics and understand the user behavior in reaction of viewing a display screen, such as, for example, to analyze the impact of a movie on the viewer behavior caused by, for example, a movie action scene, a combination of special effects, the length of a particular scene, and the like. The user measurements may also help filmmakers to better control the viewer behaviors and reactions in response to a specific scene or 3D scene and therefore improve the movie quality.

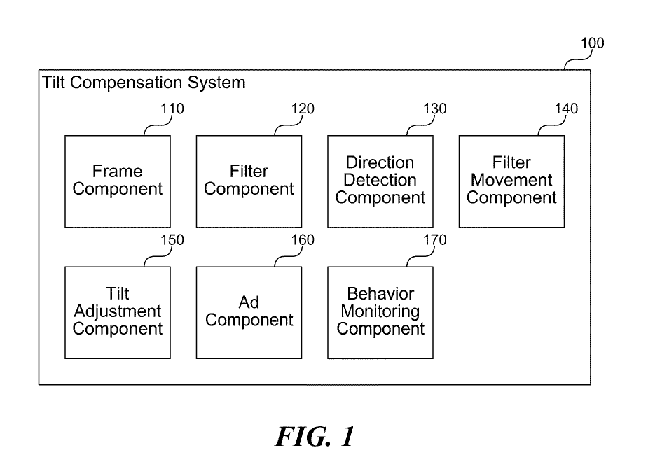

FIG. 1 is a block diagram that illustrates components of the tilt compensation system, in one embodiment. The system 100 includes a frame component 110, a filter component 120, a direction detection component 130, a filter movement component 140, a tilt adjustment component 150, an advertisement component 160, and a behavior monitoring component 170. Each of these components is described in further detail herein.

The frame component 110 provides a holder for one or more filters and can be worn by a person. For example, the frame assembly may include a glasses frame that allows the person to wear the system like normal glasses. For viewers that already wear glasses, the frame component 110 may include various other designs, such as a larger frame assembly that can be fitted over a viewer's normal glasses or a clip-on assembly that can be attached to the viewer's other glasses. The frame component 110 positions the filters in front of the viewer's eyes, whether directly or in front of other optical lenses or devices worn by the user. In some embodiments, the frame component 110 may include a cutout or gap that allows the filters to rotate beyond a threshold angle without impacting the frame.

The filter component 120 includes at least a left and a right filter for filtering stereoscopic images having a left image to be viewed by the person's left eye and a right image to be viewed by the person's right eye, wherein the filter component 120 is connected to the frame component 110 in a manner that allows rotational adjustment of the filter component 120 with respect to the frame component 110 in response to tilt of the frame component 110. The filters provide channel separation so that each eye views only the appropriate image channel. The filter component may include one or more linear-polarized, circular-polarized, color-based, shutters, or other filters to allow separate images to be delivered from a projection source to each of the person's eyes. In some embodiments, the filter component 120 may include filters having a shape determined to allow the filters to rotate a threshold angle in relation to the frame.

The direction detection component 130 detects a direction based on a reference point. For example, the component 130 may detect gravity and use gravity as a reference point to detect a downward direction that marks zero degrees of tilt. The direction detection component 130 provides a reference point to which to compare an angle of the frame component 110 so that the system can appropriately adjust a tilt of the filters to maintain a correct orientation with the visual display. The direction detection component 130 may include mechanical weights, a bubble in fluid that seeks level, a magnet, an electromechanical tilt switch, or other sensors or devices for detecting a reference point location.

The filter movement component 140 moves the filters in response to a detected difference between the reference point and an orientation of the frame component 110. For example, if a person wearing glasses embodying the system 100 tilts his head to the left, the filter movement component moves the filters to the right to maintain the filters at a particular orientation to the visual display. The filter component 120 may include an attached weight and the filter component 120 may be attached to the frame component 110 on a pivot, so that the filter movement component 140 includes the natural operation of the weight to pivot the filters in relation to the frame in a manner that the weight stays on the bottom (and thus the filter stays oriented at a particular angle regardless of the tilt of the frame).

The tilt adjustment component 150 optionally provides a calibration of the reference point direction, so that the viewer or other person can adjust the angle of the filter component 120 in relation to the detected reference point direction. In some cases, the system 100 may work correctly to keep the filters oriented (e.g., horizontally and vertically for linear filters), but the screen or projected images may be slightly off-angle so that the viewer prefers to adjust the lenses. The adjustment allows the viewer to determine an orientation at which the system 100 will attempt to keep the filters as the user moves his head. For electronic embodiments of the system, the tilt adjustment component 150 allows calibration of the electrical sensor or sensors so that the output correctly reflects a proper orientation.

The advertising component 160 optionally provides a display surface associated with the frame component 110 on which advertisements can be displayed. The advertisements may be in the form of a sticker on the frame, a painted advertisement, or an electrical display (e.g., a liquid crystal display (LCD)), on which advertisements can be displayed, scrolled, or otherwise presented to the viewer or other people. The advertisement component 160 may display advertisements in view of the viewer (e.g., above the lenses) or on the outside (e.g., along arms of glasses) for other viewers to potentially see.

The behavior monitoring component 170 optionally monitors viewer behavior and stores or transmits information about the monitored behavior for analysis. For example, the component 170 may record information about detected tilt as well as other movements, such as front to back movement, acceleration (e.g., through an accelerometer), bouncing up and down, and so forth. In some embodiments, the component 170 may include a regular or infrared camera that captures video of the viewer's movements. In some other embodiments, the component 170 may include various sensors that detect viewer emotional behaviors (e.g., a galvanic skin response sensor, a skin temperature sensor, a heat flux sensor, a heart rate sensor, or a brain wave sensor). The behavior monitoring component 170 may store the detected behavior locally, such as in a storage device attached or embedded in the frames, or may transmit the detected behavior (e.g., wirelessly using Wi-Fi or Bluetooth) to another device, such as a computer server. For stored behavior, the system 100 may provide for an operator to synchronize embodiments of the system, such as after a movie after collecting glasses, so that information detected during use can be uploaded to a computer server or other device.

Those of ordinary skill in the art will recognize that the tilt compensation system 100 may contain other components not separately described herein but commonly used in the art. For example, electrical-based embodiments may include a battery or other energy storage device as well as circuits for storing, transmitting, and accessing data. Mechanical embodiments may include various connecting devices, tensioning devices, and so forth. Embodiments of the system may be implemented in various forms, such as glasses, clip-on assemblies, clothes, headbands, hand-held formats, and so on. The components described herein may be combined or distributed in particular physical assemblies to suit particular design considerations without departing from the functionality of the system described.

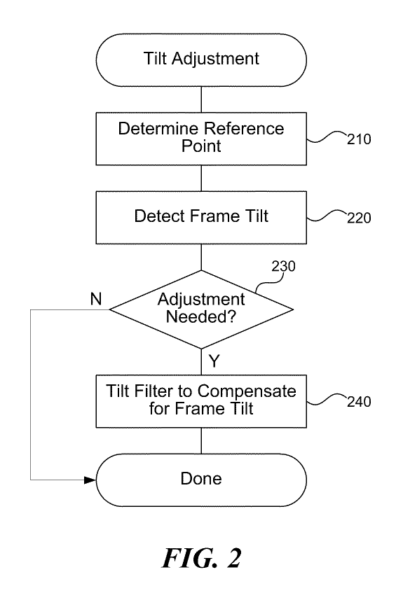

FIG. 2 is a flow diagram that illustrates processing of the tilt compensation system to adjust for tilt, in one embodiment. Beginning in block 210, the system determines an external reference point that when compared to a reference point of a filter determines an angle of tilt. For example, the filter may include a weight or other devices placed at the bottom and the external reference point may include the ground as identified by gravity. When the lens is tilted with respect to the ground, the angle between the weight and an imaginary tangential line from the ground is nonzero. Continuing in block 220, the system detects a tilt of a frame associated with the system with respect to the reference point. For example, the user of the system may tilt her head so that the system detects a nonzero tilt angle between a target position of the filter and the reference point.

Continuing in decision block 230, if the tilt indicates that an adjustment is needed, then the system continues at block 240, else the system completes. In some embodiments, the system may wait for a threshold amount of tilt before compensating or may determine that the user's head has returned vertical so that zero compensation is appropriate. Continuing in block 240, the system moves the filter to compensate for the detected frame tilt and keep the filter at a target position with respect to the reference point. For example, the system may rotate the lens in the frame mechanically or electromechanically so that even though the frame is at a new angle, the lens remains in its former angular position with respect to the reference point. After block 240, these steps conclude.

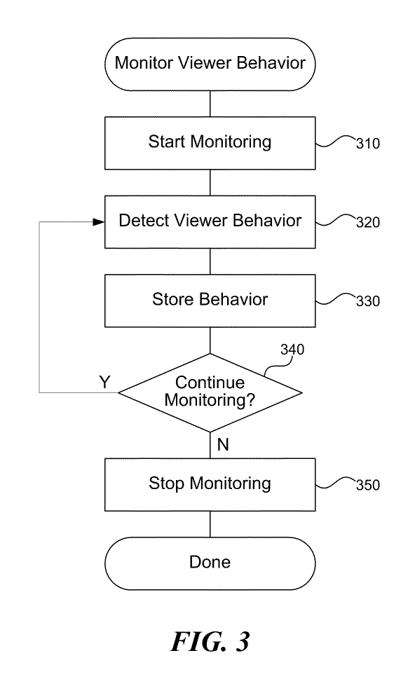

FIG. 3 is a flow diagram that illustrates processing of the tilt compensation system to monitor viewer behaviors, in one embodiment. Beginning in block 310, the system receives an indication to start monitoring user behaviors of a wearer of stereoscopic eyewear. For example, the system may detect that the wearer has unfolded stereoscopic glasses, that the wearer has put on the glasses, or that a visual presentation has begun. Various events can indicate that monitoring should begin. Continuing in block 320, the system detects a user behavior. For example, the system may detect a head tilt movement, acceleration in a particular direction, blinking, or other behavior previously configured to be monitored by the system.

Continuing in block 330, the system stores the detected user behavior for subsequent analysis. For example, the system may store the behavior in a local storage device embedded within the eyewear or may transmit the detected user behavior to a remote location for further analysis. A behavior processing system may analyze the detected behavior to determine a likely reaction of the wearer to an event in the visual display, such as a scene in a movie, or in the sound track. In some embodiments, the system stores additional information such as a time or position within the visual display at which the behavior was detected to aid in analysis of the behavior.

Continuing in decision block 340, if the system determines that monitoring is to continue, then the system loops to block 320 to await the next user behavior, else the system continues at block 350. Continuing in block 350, the system receives an indication to stop monitoring. The indication may come from an external source, such as transmitted by projection equipment, or internally, such as by user actions related to the eyewear (e.g., folding the eyewear, taking off the eyewear, flipping a switch on the eyewear, and so on). At the conclusion of monitoring, the system may store or transmit any detected behaviors to a remote device (e.g., a computer server or website) for processing. After block 350, these steps conclude.

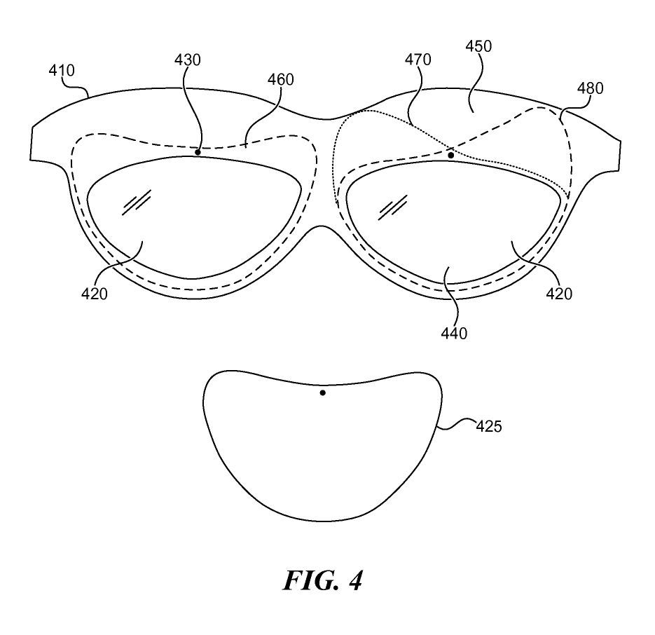

FIG. 4 illustrates a front view of eyewear embodying the tilt compensation system, in one embodiment. The eyewear includes a frame 410 with lenses 420. The lenses 420 are attached to the frame 410 at a pivot 430 that allows the lenses 420 to rotate around the pivot 430. The inset 425 shows the shape of the lens within the frame. The shape allows the lenses 420 to fill the openings in the frame 410 at a variety of angular positions of the lenses 420 around the pivot 430. The lenses 420 may include a weight 440 or extra thickness that cause extra weight so that the lenses naturally attempt to pivot to a point where the weight is closest to the ground, thereby keeping the lenses at a predetermined angle regardless of a tilt angle of the frame 410.

The dotted line 460 shows a neutral position of the lens when the frame 410 is not tilted. The dotted line 470 shows a first tilt position of the lens that occurs when the frame is tilted 410 in one direction. At the point where the lens edge would impact the frame 410, the frame 410 may include a cutout that allows the lens to pivot farther by protruding from the frame 410. The dotted line 480 shows a second tilt position of the lens that occurs when the frame is tilted in the other direction. The figure also shows potential advertising space 450, which may similarly be included on the side arms of the eyewear for placing advertisements.

Although illustrated mechanically in FIG. 4, the tilt compensation may also utilize electromechanical devices, such as tilt meters, actuators, or electromagnets to move the lenses, and so forth. Moreover, the design shown in FIG. 4 is one of many possible variations. For example, the system may include a round lens with bearings around the outer edge so that the lens can rotate at any angle with respect to the frame. Note that the system may include lens lock preventers (e.g., on the lens frame or the lens) to prevent the lens from being involuntarily locked in an undesired angle while rotating. The lens may also float in fluid with an air bubble, levitate using magnets and electric charges, or other mechanism for maintaining the lens orientation with respect to an external reference point. Those of ordinary skill in the art will recognize many techniques and designs for building eyewear that allows the lenses to rotate separately from the frame, as described herein.

In some embodiments, the tilt compensation system is provided in an assembly that can be attached to existing eyewear of a viewer. For viewers that already wear glasses, wearing an additional pair of glasses over their existing glasses can be frustrating and lead to a poor fit and viewing experience. Thus, the system may provide an embodiment that attaches easily to existing glasses and provides the moveable filters without a bulky additional frame. In some embodiments, the system may include a frame with members that protrude for engaging with existing eyewear, so that the system frame fits comfortably and securely over the existing eyewear.

In some embodiments, the tilt compensation system includes sealed lenses that can be removed from the frame. Eyewear associated with the system may be used briefly by many viewers and need to be cleaned in between uses. For example, a movie theater may provide the eyewear to each movie viewer. Removable lenses allow the system to be cleaned without damaging the tilt mechanism or scratching the lenses. In some embodiments, the tilt compensation system is sealed and can be removed from the frame (e.g., for cleaning the eyewear and preventing a liquid from entering the tilt compensation system). Alternatively, the frame or the tilt compensation system are not sealed and include holes or gaps on the edges of the frame or of the system to allow cleaning liquid to evacuate and dry more easily.

In some embodiments, the tilt compensation system includes a facility for ensuring correct assembly of eyewear associated with the system. Assembling stereoscopic eyewear requires care, because assembly workers need to place the correct filter in each eye position, and flipping the lens may produce an undesirable result. Thus, the system may include keyway holes or other facilities in the lenses that prevent the lenses from fitting into the frame in an incorrect orientation or position. The system may also include different sized pivots, so that the lens with a smaller pivot hole cannot be placed on the larger pivot, and the lens with the larger pivot hole would be visibly loose on the smaller pivot.

From the foregoing, it will be appreciated that specific embodiments of the tilt compensation system have been described herein for purposes of illustration, but that various modifications may be made without deviating from the spirit and scope of the invention. Accordingly, the invention is not limited except as by the appended claims.

I/We claim:

1. A method for automatically adjusting stereoscopic filters to compensate for tilt by a user, the method comprising:
determining an external reference point that when compared to a reference point of a filter determines an angle of tilt;
detecting a tilt of a frame associated with the system with respect to the reference point;
determining whether an adjustment to an angle of the filter is needed to restore a target angle between the filter and the reference point; and
if an adjustment is needed, automatically moving the filter to compensate for the detected frame tilt and to keep the filter at the target angle with respect to the reference point.

2. The method of claim 1 wherein determining the external reference point comprises attaching a weight to the bottom of the filter so that the weight moves to a low point in response to gravitational force.

3. The method of claim 1 wherein the filter is at least part of a lens in a pair of stereoscopic eyewear.

4. The method of claim 1 wherein detecting the tilt comprises determining that the user tilted the user's head creating a nonzero tilt angle between a target position of the filter and the determined reference point.

5. The method of claim 1 wherein detecting the tilt comprises using a mechanical weight attached to the filter to cause the filter to orient to the target position using gravitational force.

6. The method of claim 1 wherein detecting the tilt comprises embedding the filter in fluid and sealing an attachment with a bubble to the filter to cause the filter to orient to the target position using flotation force of the bubble.

7. The method of claim 1 wherein detecting the tilt comprises receiving a reading from an electronic tilt sensor.

8. The method of claim 1 wherein determining whether an adjustment is needed comprises determining whether the filter is offset from a polarization angle of a display surface being viewed by the user through the filter.

9. The method of claim 1 wherein determining whether an adjustment is needed comprises determining whether the angle of the filter exceeds a threshold amount of tilt.

10. The method of claim 1 wherein moving the filter comprises rotating the filter in the frame mechanically so that even though the frame is at a new angle, the filter remains in its former angular position with respect to the reference point.

11. The method of claim 1 wherein moving the filter comprises rotating the filter in the frame electromechanically using one or more electronic actuators.

12. A system for automatically adjusting polarized filters in stereoscopic eyewear to maintain a target filter orientation in response to wearer head tilt, the system comprising:
a frame component configured to provide a holder for one or more filters and to be worn by a person;
one or more filter components that include at least a left and a right filter for filtering stereoscopic images having a left image to be viewed by the person's left eye and a right image to be viewed by the person's right eye, wherein the filter component is connected to the frame component in a manner that allows rotational adjustment of the filter component with respect to the frame component in response to tilt of the frame component;
a direction detection component configured to detect a direction of the one or more filter components based on a reference point; and
a filter movement component configured to allow movement of the filters in response to a detected difference between the reference point and the target filter orientation of the one or more filter components.

13. The system of claim 12 wherein the frame component is further configured to a glasses frame that allows the person to wear the system like normal glasses.

14. The system of claim 12 wherein the frame component is further configured to attach over other eyewear already worn by the person.

15. The system of claim 12 wherein the frame component is further configured to include a cutout that allows the filters to rotate beyond a threshold angle without impacting the frame.

16. The system of claim 12 wherein the filter components are further configured to include one or more linear-polarized filters, circular-polarized filters, color-based filters, or shutters to allow separate images to be delivered from a projection source to each of the person's eyes.

17. The system of claim 12 wherein the filter components include filters having a shape determined to allow the filters to rotate a threshold angle in relation to the frame.

18. The system of claim 12 wherein the direction detection component is further configured to detect gravity and use gravity as a reference point to detect a downward direction that represents zero degrees of tilt of the one or more filters.

19. The system of claim 12 wherein the direction detection component provides the reference point to which to compare an angle of the frame component so that the system can appropriately adjust a tilt of the filters to maintain the target orientation of the filters with respect to a visual display.

20. The system of claim 12 further comprising a tilt adjustment component configured to provide a calibration of the reference point direction, so that the person can adjust the target orientation of the filter component in relation to the detected reference point direction.

21. The system of claim 12 further comprising an advertising component configured to provide a display surface associated with the frame component on which advertisements can be displayed.

22. The system of claim 12 further comprising a behavior monitoring component configured to monitor behavior of the person and store or transmit information about the monitored behavior for subsequent analysis.

23. A method for monitoring behavior of a wearer of stereoscopic eyewear, the method comprising:
receiving an indication to start monitoring user behavior of the wearer of stereoscopic eyewear;
detecting a user behavior by the wearer of the stereoscopic eyewear;
storing the detected user behavior for subsequent analysis in a local storage device embedded within the eyewear; and
upon detecting an indication to stop monitoring user behavior, stopping monitoring.
